(19) United States
(12) Patent Application Publication
(10) Pub. No.: US 2007/0059978 A1
(43) Pub. Date: Mar. 15, 2007

(54) Connector system

(76) Inventor: Matthew Rohrbach, San Francisco, CA (US)

Correspondence Address: TOWNSEND AND TOWNSEND AND CREW, LLP, TWO EMBARCADERO CENTER, 8TH FLOOR, SAN FRANCISCO, CA, 94111-3834, US

(21) Appl. No.: 11/228,414

(22) Filed: Sep. 15, 2005

(51) Int. Cl. H01R 11/00

(52) U.S. Cl. 439/502

(57) ABSTRACT

A connector system and connector are disclosed. In a first aspect the connector system comprises a first connector having a first electrical connection for a first protocol and having a second electrical connection coupled to the first electrical connection for a second protocol. The connector system further includes a second connector coupled to and integrated with the first connector. The second connector has a third electrical connection for the second protocol wherein there is no cable between the first and second electrical connectors. In a second aspect, the connector comprises a housing; and a first electrical connection having a first protocol within the housing. The connector also includes a second electrical connection coupled to the first electrical connection and having a second protocol within the housing. Finally, the connector includes a screw assembly mechanism internal to the housing and accessible by a user to facilitate assembly or disassembly of the connector from a data source.

### FIELD OF THE INVENTION

The present invention relates generally to a connector system and more specifically to a connector system that is utilized for connecting a data source to a display.

### BACKGROUND OF THE INVENTION

It is known that many computers and other data sources are connected to a display device by means of a connector system. Conventional (legacy) displays, or other display devices such as projectors, often have a low end connector such as a VGA connector which is designed to be used to connect the display device to an appropriate signal source, such as that provided by a computer. However, contemporary computers and other sources of a visual or audio signal often have a high end digital video connector such as a DVI output connector instead of a VGA output connector.

For example, FIG. 1 shows a conventional system 10 for connecting together a VGA display with a computer. The conventional system 10 comprises a cable 12 connected to a VGA connector 14, and another connector 16 connected via a second cable 18 to a DVI connector 20. The DVI connector 20 is then attached/plugged in to an audio or video signal source 22, which in this embodiment is a personal computer such as a Macintosh computer.

Using the conventional connection system 10, it is possible to connect a VGA cable 12 to a DVI cable 18, and to realize a successful, though not always highest quality, signal transfer. However, because many contemporary computers have become miniaturized in size and length, the larger size and longer lengths of the cables often result in a connection system which may be larger and longer than the computer itself, resulting in considerable inconvenience, loss of visual attractiveness, and degraded quality of signal transfer.

Utilizing such a conventional system 10 to connect a VGA and a DVI connector, it is also necessary for the user to manually tighten the two screws 24a and 24b located on the VGA connector 14 and the two screws 26a and 26b located on the DVI connector 20 so that a secure attachment can be made, in order to provide the highest possible signal quality and also to avoid interruptions or distortions in signal quality. However, tightening the afore-mentioned screws can be very difficult for people with larger hands or fingers, or who must adjust the connectors while working in very small spaces.

Accordingly, what is needed is a system and method for connecting a VGA or other type of connector from a display device or the like to a DVI connection on a signal source such as a personal computer. The system and method needs to be as compact as possible. The system and method also needs to enable the user to adjust connectors to form a secure connection in as easy and simple/efficient a way as possible, thereby creating a high quality signal transfer without image distortion or loss. The present invention addresses such a need.

### SUMMARY OF THE INVENTION

A connector system and connector are disclosed. In a first aspect the connector system comprises a first connector having a first electrical connection for a first protocol having a second electrical connection coupled to the first electrical connection for a second protocol. The connector system further includes a second connector coupled to and integrated with the first connector. The second connector has a third electrical connection for the second protocol wherein there is no cable between the first and second electrical connectors.

In a second aspect, the connector comprises a housing; and a first electrical connection having a first protocol within the housing. The connector also includes a second electrical connection coupled to the first electrical connection and having a second protocol within the housing. Finally, the connector includes a screw assembly mechanism internal to the housing and accessible by a user to facilitate assembly or disassembly of the connector from a data source.

### BRIEF DESCRIPTION OF THE DRAWINGS

FIG. 1 shows a conventional system 10 for connecting together a VGA display with a computer.

FIG. 2 shows a connector system in accordance with the present invention.

FIG. 3 shows a top view of a connector in accordance with the present invention.

FIG. 4 shows a side view of a connector in accordance with the present invention.

FIG. 5 shows a fixed nut and hex in accordance with the present invention.

FIG. 6 shows a screw which fits onto the hex shown in FIGS. 4a and 4b.

FIG. 7 shows a system which utilizes a connector system.

### DETAILED DESCRIPTION

The present invention relates generally to a connector system and more specifically to a connector system that is utilized for connecting a data source to a display. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A connector system in accordance with the present invention allows for an integrated and compact connection between a data source, which may be but is not limited to being a computer, and a display. Accordingly, what is provided is a connector which incorporates the standard functionality of two different connection protocols in a single connector. In so doing, a system is provided which is more versatile and can be utilized in a more robust way than conventional connector systems. To describe the features of the present invention in more detail, refer now to the following figures.

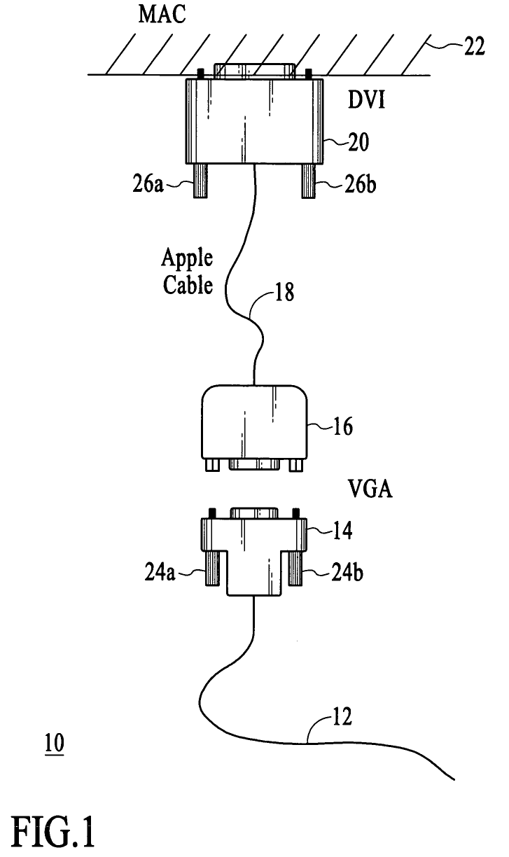

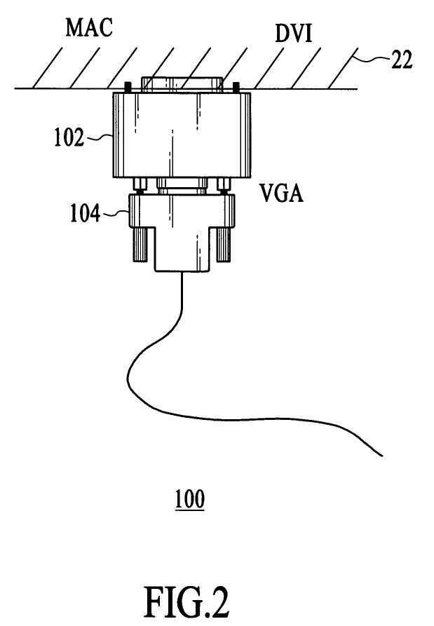

FIG. 2 shows a connector system 100 in accordance with the present invention. The connector system 100 comprises a high end connector such as a DVI connector 102 in accordance with the present invention coupled to a legacy connector such as a VGA connector 104. In this embodiment the DVI connector 102 is coupled to a data source which is a Macintosh computer. In this integrated system, the connector cable 18 and VGA connector 16 shown in FIG. 1 are no longer needed, thereby reducing the length of cable and number of connecting devices required.

Although the connector system 100 utilizes a DVI connector 102 and a VGA connector 104, one of ordinary skill in the art recognizes that there are other types of connectors between data sources such as computers and display devices which could be used, and that the connector system 100 in accordance with the present invention would still provide the same functions.

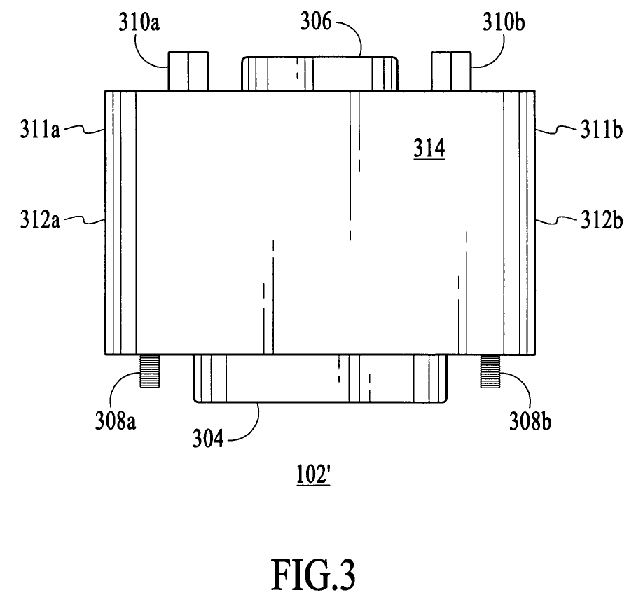

FIG. 3 shows a more detailed top view of a connector 102′ in accordance with the present invention. The connector 102′ comprises a housing 314, a screw assembly mechanism, a first electrical connection, for example a DVI connection 304 and a second electrical connection, for example, a VGA connection 306. The screw assembly mechanism includes two screws 308a and 308b internal to the housing 314 for connecting the first electrical connection 304 to the data source (not shown) which are configured so that the heads are almost flush with but slightly above the connector surface, and knobs 312a and 312b which are also internal to the housing 314 for connecting the second electrical connection 102 to a display device (not shown) and which encase their respective screws 308a and 308b. Openings 311a and 311b expose the knobs 312a and 312b respectively. The tightening or loosening action of the screws 308a and 308b is actuated by a finger by turning knobs 312a and 312b in a clockwise or counter clockwise direction.

Referring again to FIG. 3, the VGA connection 306 of the connector 102′ has two nuts 310a and 310b. These two screws 310a and 310b are fastened to the VGA connector coming from the display device (not shown) in the conventional way.

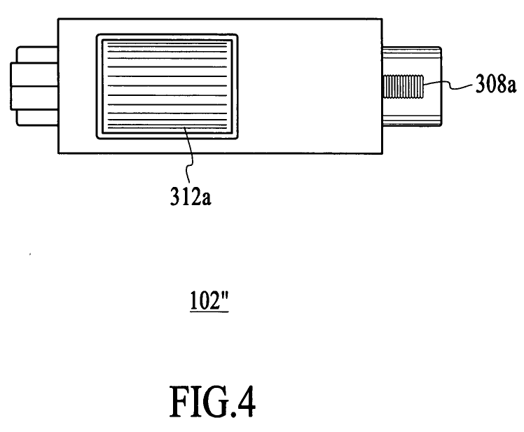

FIG. 4 shows a side view of the connector 102″ in accordance with the present invention. The knob 312a on the side of the connector 102″ is shown more clearly in this figure. A similar knob 312b (not shown in FIG. 4) is also located on the opposite side of the connector 102″, as shown in FIG. 3. As before mentioned, the knobs 312a and 312b (not shown) are used to move their corresponding screws 308a and 308b (not shown) in and out, thereby tightening or loosening the connection between the connector 102″ and the computer (not shown) attached thereto.

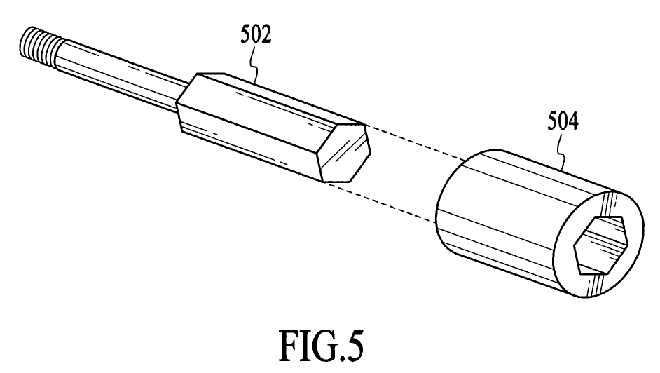

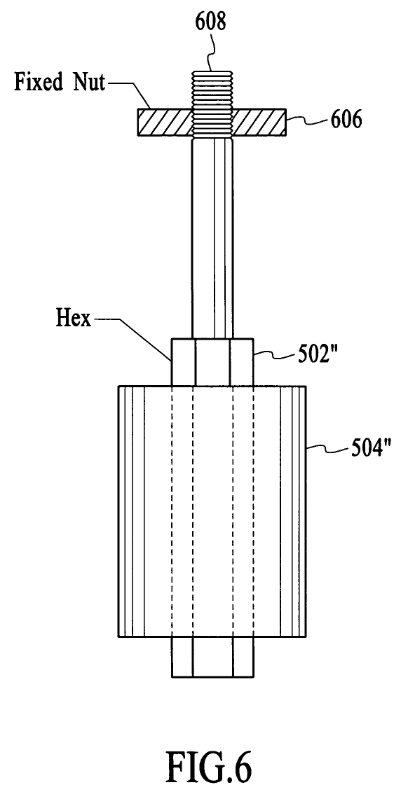

To more clearly describe the operation of the screw assembly mechanism 500 in accordance with the present invention, refer now to FIG. 5. FIG. 5 shows a hex 502 and knob 504 in accordance with the present invention. FIG. 6 shows how the hex 502′ fits into the knob 504′. The hex 502″ is also attached to a fixed nut 606 and has a screw tip 608. This system provides for stabilizing the connection between the connector 102 (not shown) and the DVI connection located on the computer (not shown).

Although in this embodiment the DVI connection includes the inventive screw assembly shown in FIGS. 5 and 6, one of ordinary skill in the art recognizes that VGA, DVI or other similar connectors could also include such a screw assembly, and the screw assembly would function in the same manner.

Accordingly, what is provided is a connector which incorporates the functionality of two different protocols (i.e., VGA and DVI) in a single connector. In so doing, a system is provided which is more versatile and can be utilized in a more robust way than previous connector systems.

One should readily recognize that although the present invention has been described in conjunction with a particular type of connector, this system could be used within a variety of environments and they would be within the spirit and scope of the present invention.

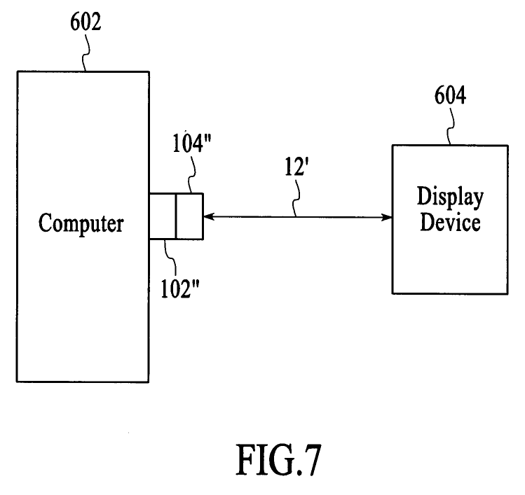

FIG. 7 shows a system which includes a connector system in accordance with the present invention. As is seen, the connector system comprises a VGA connector 104″, a cable 12′ connecting the VGA connector 104″ and a display device 604, and a DVI connector 102″ connected to a computer 602. In this embodiment, either connector 102″ or 104″ could include the connection interface in accordance with the present invention. The computing device could be any source of data including but not limited to a computer, PDA, or portable computer. Similarly, the display device could be any display device including but not limited to a video projector, high definition television, portable display, etc.

The connector in accordance with the present invention is compact enough that its size does not exceed the size of the personal computer or other source of audio or video signal, thereby eliminating user inconvenience and visual unattractiveness. The connector also enables the user to easily adjust the tightness of the connection by means of a screw assembly system, thereby providing a means for simply and efficiently forming a secure connection even in a small or awkward space, and creating a high quality signal transfer without image distortion or loss.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A connector system comprising:
a first connector having a first electrical connection for a first protocol and having a second electrical connection coupled to the first electrical connection for a second protocol; and
a second connector coupled to and integrated with the first connector; the second connector having an electrical connection for the second protocol wherein there is no cable between the first and second electrical connectors.

2. The connector system of claim 1 wherein one of the first and second protocols comprises a DVI protocol and the other of the first and second protocols comprises a VGA protocol.

3. The connector system of claim 1 wherein the first connector is adapted to be coupled to a data source.

4. The connector system of claim 2 wherein the second connector is adapted to be coupled to the display device via a cable.

5. The connector system of claim 4 wherein the first connector comprises:
a housing; and
a screw assembly mechanism internal to the housing, the screw assembly mechanism comprising a plurality of screws for connecting the first electrical connection to the data source; and a plurality of knobs, each knob enclosing one of the screws and each knob being exposed via an aperture in the housing; wherein a knob can be turned to tighten or loosen its respective screw to allow for assembly or disassembly of the first connector from the data source.

6. The connector system of claim 1 wherein the data source can be any of a portable computer, personal digital assistant, personal computer, video camera, or similar device.

7. The connector system of claim 1 wherein the display device can be any of a video camera, computer display, video projector, or similar device.

8. A connector comprising:
a housing;
a first electrical connection having a first protocol within the housing;
a second electrical connection coupled to the first electrical connection and having a second protocol within the housing;
a screw assembly mechanism internal to the housing and accessible by a user to facilitate assembly or disassembly of the connector from a data source.

9. The connector of claim 8 wherein the screw assembly mechanism comprises:
a plurality of screws for connecting the first electrical connection to the data source; and
a plurality of knobs, each knob enclosing one of the screws and each knob being exposed via an aperture in the housing; wherein a knob can be turned to tighten or loosen its respective screw to allow for assembly or disassembly of the first connector from the data source.

10. The connector of claim 8 wherein one of the first and second protocols comprises a DVI protocol and the other of the first and second protocols comprises a VGA protocol.

11. The connector of claim 9 wherein the data source can be any of a portable computer, personal digital assistant, personal computer, video camera, or similar device.

12. The connector of claim 11 wherein the display device can be any of a video camera, computer display, video projector, or similar device.

13. A device comprising:
a data source; and
a connector coupled to the data source comprising a housing; a first electrical connection having a first protocol within the housing; a second electrical connection coupled to the first electrical connection and having a second protocol within the housing; a screw assembly mechanism internal to the housing and accessible by a user to facilitate assembly or disassembly of the connector from a data source.

14. The device of claim 13 wherein the screw assembly mechanism comprises:
a plurality of screws for connecting the first electrical connection to the data source; and
a plurality of knobs, each knob enclosing one of the screws and each knob being exposed via an aperture in the housing; wherein a knob can be turned to tighten or loosen its respective screw to allow for assembly or disassembly of the first connector from the data source.

15. The device of claim 14 wherein one of the first and second protocols comprises a DVI protocol and the other of the first and second protocols comprises a VGA protocol.

16. The device of claim 15 wherein the data source can be any of a portable computer, personal digital assistant, personal computer and video camera.

17. The device of claim 16 wherein the display device can be any of a video camera, computer display and video projector.

18. A connector comprising:
a housing;
a DVI electrical connection within the housing;
a VGA connection coupled to the DVI electrical connection within the housing;
a screw assembly mechanism internal to the housing and accessible by a user to facilitate assembly or disassembly of the connector from a data source, wherein the screw assembly mechanism comprises two screws for connecting the DVI electrical connection to the data source; and two knobs, each knob enclosing one of the screws and each knob being exposed via an aperture in the housing; wherein a knob can be turned to tighten or loosen its respective screw to allow for assembly or disassembly of the first connector from the data source.
